(19) United States
(12) Patent Application Publication
(10) Pub. No.: US 2004/0119690 A1
(43) Pub. Date: Jun. 24, 2004

(54) System and method to interact remotely with an application displayed on a display device

(76) Inventors: Scott W. Watters, Forest Grove, OR (US); Edward R. Harrison, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/330,847

(22) Filed: Dec. 24, 2002

(51) Int. Cl. G09G 5/08

(52) U.S. Cl. 345/158

(57) ABSTRACT

A system and method to interact remotely with an application displayed on a display device are disclosed. A contact position of a light beam received from a light emitting remote device is detected. Position coordinates corresponding to the contact position are further extracted. The position coordinates are further processed to obtain respective processed coordinates for further transmission to a display device.

### FIELD OF THE INVENTION

The present invention relates generally to consumer electronic devices. More particularly, the present invention relates to a system and method to interact remotely with an application displayed on a display device.

### BACKGROUND OF THE INVENTION

Recently, there have been several attempts to implement computer functionality to display devices, such as, for example, television screens. In some of these available implementations, an on-screen pointer that interacts with a displayed application is moved using a remote control containing a trackball and/or arrow keys. Other available systems use a keyboard and/or mouse, which can be either connected via cable directly to the television, or may work wirelessly using infrared technology.

However, the movement of the on-screen pointer using the arrow keys is slower than the needs of end users. Moreover, trackballs are also generally ineffectual because of the difficulty of positioning a pointer from a great distance away from the television screen. In addition, the above input methods and systems require a flat surface on which to lie while in use, which may or may not always be adequate to enable accurate functionality of the systems.

### BRIEF DESCRIPTION OF THE DRAWINGS

The present invention is illustrated by way of example and not limitation in the figures of the accompanying drawings in which like references indicate similar elements and in which:

FIG. 1 illustrates one embodiment of a system to interact remotely with an application displayed on a display device;

FIG. 2 illustrates one embodiment of a method to interact remotely with an application displayed on a display device;

FIG. 3 illustrates a diagrammatic representation of a machine in the exemplary form of a computer system within which a set of instructions may be executed.

### DETAILED DESCRIPTION

According to embodiments described herein, a system and method to interact remotely with an application displayed on a display device are disclosed.

As will be described in more detail below, a contact position of a light beam received from a light emitting remote device is detected. Position coordinates corresponding to the contact position are further extracted. The position coordinates are further processed to obtain respective processed coordinates for further transmission to a display device.

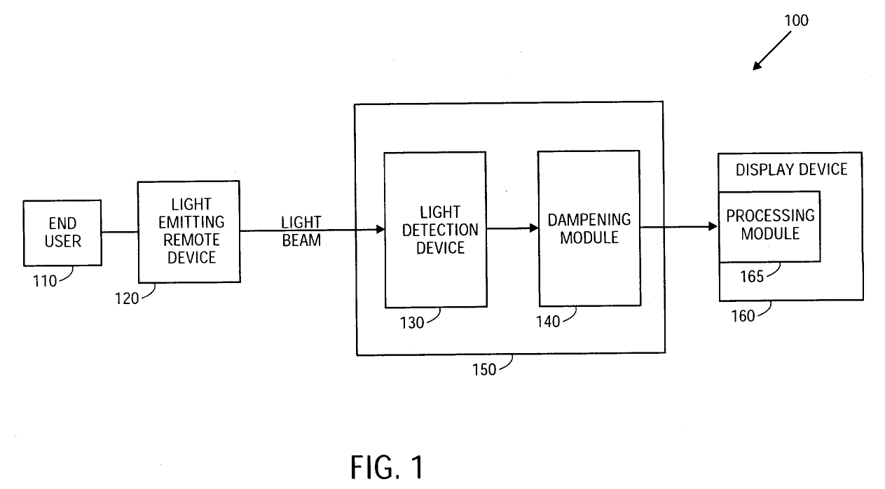

FIG. 1 illustrates one embodiment of a system 100 to interact remotely with an application displayed on a display device. Referring to FIG. 1, in one embodiment, the system 100 includes a light emitting remote device 120 coupled to one or more end users 110. The light emitting remote device 120 emits a light beam upon receipt of a command from the end user 110. In one embodiment, the light emitting remote device 120 is a stylus-pointing device, such as, for example, a laser pointer, which emits invisible laser light. Alternatively, the remote device 120 may be any type of remote control device capable of emitting light beams, such as, for example devices capable of emitting infrared or ultraviolet light beams.

The system 100 further includes a light detection device 130 coupled to a dampening module 140 and to a display device 160. In one embodiment, the light detection device 130 and the dampening module 140 are separate components of the system 100. Alternatively, the light detection device 130 and the dampening module 140 may reside within a single detection and dampening device 150 coupled to the display device 160.

The light detection device 130 is a programmable hardware and/or software device to perform the detection and extraction operations described herein. The dampening module 140 is a programmable hardware and/or software module to perform the dampening operations described herein.

In one embodiment, the display device 160 further includes a processing module 165 and a display screen (not shown). The processing module 165 is a programmable hardware and/or software module to perform the processing operations described herein. In one embodiment, the display screen resides within the display device 160. Alternatively, the display screen may be remotely located and may be coupled to the display device 160.

In one embodiment, the display device 160 is a television set having a television screen. The light detection device 130 is a membrane layer adjacently coupled to the television screen of the television set to receive the light beam emitted by the light emitting remote device 120. For example, the membrane layer may reside on the surface of the television screen, thus covering completely the viewing area of the television screen. The light detection device 130 detects a contact position of the light beam on its surface and further extracts raw position coordinates (x,y) corresponding to the contact position. The light detection device 130 further transmits the raw position coordinates to the dampening module 140.

In one embodiment, the dampening module 140 processes the position coordinates of the contact position of the light beam to obtain processed position coordinates. For example, the dampening module 140 dampens the position coordinates to eliminate hysteresis, i.e. to smooth the movements of the contact position of the light beam onto the light detection device 130, which appear due to the imperceptible movements of the end user's hand while handling the light emitting remote device 120. The dampening module 140 uses one of many known dampening algorithms available to eliminate the hysteresis effect. The processed position coordinates are subsequently transmitted to the processing module 165 within the display device 160.

In one embodiment, the processing module 165 further processes the received coordinates to cause a pointer that interacts with an application displayed on the television screen to move on the television screen according to the processed coordinates. Since the end user 110 does not see the contact point of the invisible light beam on the light detection device 130 and, respectively, on the adjacent television screen, the change in position of the pointer on the television screen based on the dampened (x,y) position coordinates provides the end user 110 with unique feedback as to the intended position of the pointer. The visualization of the dampened position, as opposed to the raw unprocessed position, enables the visual system of the end user 110 to perform fine positioning of the pointer on the television screen.

In an alternate embodiment, the display device 160 is a projection device and the display screen is a projection screen located opposite to the projection device to receive the information and to display an application for the end user 110.

The light detection device 130 is a camera positioned opposite to the projection screen to detect a contact position of the light beam on the surface of the projection screen and further to extract raw position coordinates (x,y) corresponding to the contact position. The light detection camera 130 is sensitive to the specific light beam used and performs the detection operations such that the end user 110 never perceives the contact point of the light beam with the projection screen.

The light detection device 130 further transmits the raw position coordinates to the dampening module 140. In one embodiment, the light detection device 130 is separate from the display device 160. Alternatively, the light detection device 130 may be integral to the display device 160.

The dampening module 140 processes the position coordinates of the contact position of the light beam to obtain processed position coordinates, as discussed in detail above, and subsequently transmits the processed coordinates to the processing module 165 within the display device 160. In one embodiment, the dampening module 140 is separate from the display device 160. Alternatively, the dampening module 140 may be integral to the display device 160.

The processing module 165 further processes the received coordinates to cause a pointer that interacts with the application displayed on the projection screen to move on the projection screen according to the processed coordinates.

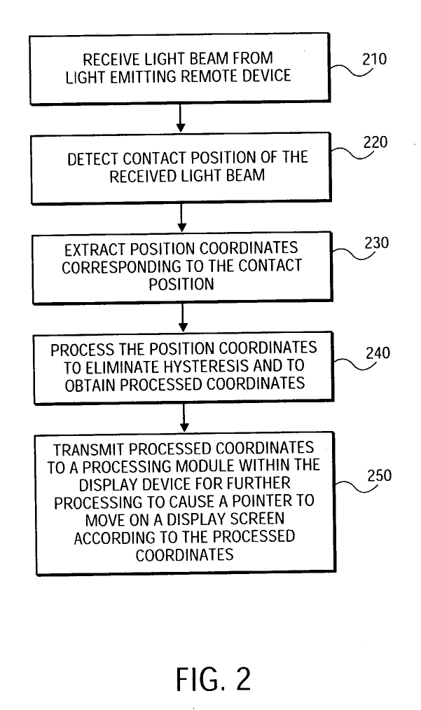

FIG. 2 illustrates one embodiment of a method to interact remotely with an application displayed on a display device. As shown in FIG. 2, at processing block 210, a light beam is received from a light emitting remote device 120.

At processing block 220, a contact position of the light beam is detected. At processing block 230, position coordinates corresponding to the contact position of the light beam are extracted.

At processing block 240, the position coordinates are processed to eliminate hysteresis and to obtain processed coordinates. Finally, at processing block 250, the processed coordinates are transmitted to a processing module 165 within a display device 160 for further processing to cause a pointer to move on a display screen according to the processed coordinates.

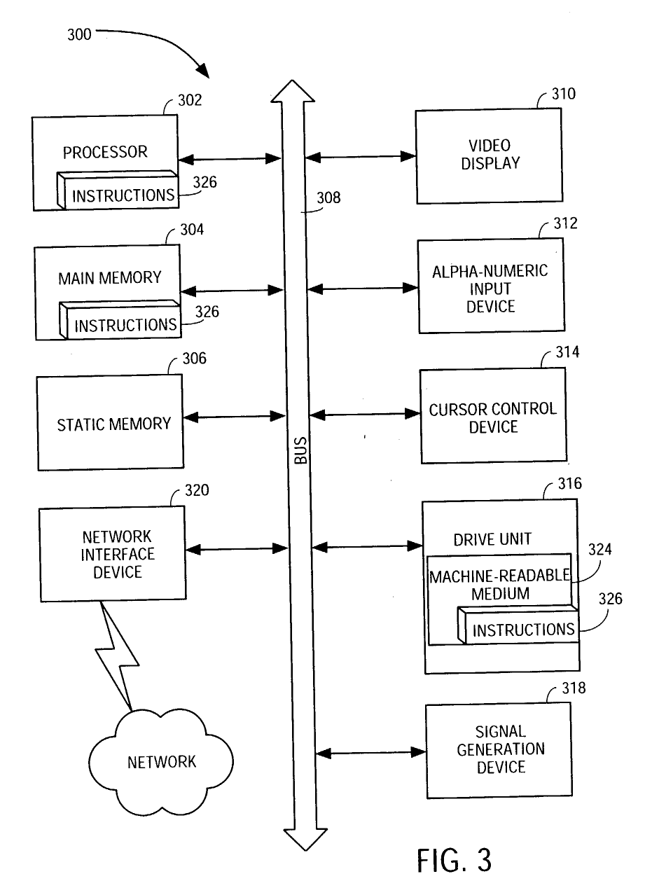

FIG. 3 illustrates a diagrammatic representation of a machine in the exemplary form of a computer system 300 within which a set of instructions, for causing the machine to perform any one of the methodologies described in detail above, may be executed. In alternative embodiments, the machine may comprise a television set or a video projection device, or may be coupled to a network router, a network switch, a network bridge, Personal Digital Assistant (PDA), a cellular telephone, a web appliance or any machine capable of executing a sequence of instructions that specify actions to be taken by that machine.

The computer system 300 includes a processor 302, a main memory 304 and a static memory 306, which communicate with each other via a bus 308. The computer system 300 further includes a video display unit 310 (e.g., a liquid crystal display (LCD) or a cathode ray tube (CRT)). The computer system 300 may also include an alphanumeric input device 312 (e.g., a keyboard), a cursor control device 314 (e.g., a mouse), a disk drive unit 316, a signal generation device 18 (e.g., a speaker), and a network interface device 320.

The disk drive unit 316 includes a machine-readable medium 324 on which is stored a set of instructions (i.e., software) 326 embodying any one, or all, of the methodologies described above. The software 326 is also shown to reside, completely or at least partially, within the main memory 304 and/or within the processor 302. The software 326 may further be transmitted or received via the network interface device 320.

Thus, a system and method to interact remotely with an application displayed on a display device have been disclosed. Embodiments of the present invention may be implemented in software programs executed on some form of a processing core (such as a signal processor or a central processing unit of a microprocessor or microcontroller) or otherwise implemented or realized upon or within a machine-readable or computer readable medium. A machine-readable medium includes any mechanism for storing or transmitting information in a form readable by a machine (e.g., a computer or a switch). For example, a machine readable medium includes read-only memory (“ROM”); random-access memory (“RAM”); magnetic disk storage media; optical storage media; flash memory devices; electrical, optical, acoustical, or other form of propagated signals (i.e., carrier waves, infrared signals, digital signals, etc.); or any other type of media suitable to store or to transmit information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
detecting a contact position of a light beam received from a light emitting remote device;
extracting position coordinates corresponding to said contact position; and
processing said position coordinates to obtain respective processed coordinates for further transmission to a display device.

2. The method according to claim 1, further comprising:
transmitting said processed coordinates to said display device; and
processing said processed coordinates at said display device to cause a pointer to move on a display screen of said display device.

3. The method according to claim 1, wherein said display device is a television set.

4. The method according to claim 1, wherein said detecting further comprises receiving said light beam from said remote device upon activation of said light beam by an end user.

5. The method according to claim 1, wherein processing said position coordinates further comprises dampening said position coordinates to eliminate hysteresis.

6. A system comprising:
means for detecting a contact position of a light beam received from a light emitting remote device;
means for extracting position coordinates corresponding to said contact position; and
means for processing said position coordinates to obtain respective processed coordinates for further transmission to a display device.

7. The system according to claim 6, further comprising:
means for transmitting said processed coordinates to said display device; and
means for processing said processed coordinates at said display device to cause a pointer to move on a display screen of said display device.

8. The system according to claim 6, further comprising means for receiving said light beam from said remote device upon activation of said light beam by an end user.

9. The system according to claim 6, further comprising means for dampening said position coordinates to eliminate hysteresis.

10. A computer readable medium containing executable instructions, which, when executed in a processing system, cause said processing system to perform a method comprising:
detecting a contact position of a light beam received from a light emitting remote device;
extracting position coordinates corresponding to said contact position; and
processing said position coordinates to obtain respective processed coordinates for further transmission to a display device.

11. The computer readable medium according to claim 10, wherein said method further comprises:
transmitting said processed coordinates to said display device; and
processing said processed coordinates at said display device to cause a pointer to move on a display screen of said display device.

12. The computer readable medium according to claim 10, wherein said detecting further comprises receiving said light beam from said remote device upon activation of said light beam by an end user.

13. The computer readable medium according to claim 10, wherein processing said position coordinates further comprises dampening said position coordinates to eliminate hysteresis.

14. An apparatus comprising:
a light detection device to detect a contact position of a light beam received from a light emitting remote device and to extract position coordinates corresponding to said contact position; and
a dampening module coupled to said light detection device to process said position coordinates to obtain respective processed coordinates for further transmission to a display device.

15. The apparatus according to claim 14, wherein said display device is a television set.

16. The apparatus according to claim 14, wherein said light detection device further receives said light beam from said remote device upon activation of said light beam by an end user.

17. The apparatus according to claim 14, wherein said dampening module further dampens said position coordinates to eliminate hysteresis.

18. The apparatus according to claim 15, wherein said light detection device is a membrane layer adjacently coupled to a television screen of said television set.

19. The apparatus according to claim 14, wherein said display device is a projection device.

20. The apparatus according to claim 19, wherein said light detection device is a camera capable to detect said contact position of said light beam on a projection screen of said projection device.

21. The apparatus according to claim 14, wherein said dampening module further transmits said processed coordinates to a processing module of said display device for further processing to cause a pointer to move on a display screen of said display device.

22. A system comprising:
a light detection device to detect a contact position of a light beam received from a light emitting remote device and to extract position coordinates corresponding to said contact position;
a dampening module coupled to said light detection device to process said position coordinates to obtain respective processed coordinates; and
a display device coupled to said dampening module to receive said processed coordinates from said dampening module and to further process said processed coordinates to cause a pointer to move on a display screen of said display device.

23. The system according to claim 22, wherein said display device is a television set and said display screen is a television screen of said television set.

24. The system according to claim 22, wherein said light detection device further receives said light beam from said remote device upon activation of said light beam by an end user.

25. The system according to claim 22, wherein said dampening module further dampens said position coordinates to eliminate hysteresis.

26. The system according to claim 22, wherein said display device is a projection device and said display screen is a projection screen of said projection device.

27. The system according to claim 22, wherein said light beam is an invisible laser light.

28. The system according to claim 22, wherein said light beam is an infrared light beam.

29. The system according to claim 22, wherein said light beam is an ultraviolet light beam.
